(19) United States
(12) Patent Application Publication
(10) Pub. No.: US 2016/0076695 A1
(43) Pub. Date: Mar. 17, 2016

(54) Wig Hanger

(71) Applicant: Janice Henington, Summertown, TN (US)

(72) Inventor: Janice Henington, Summertown, TN (US)

(21) Appl. No.: 14/711,410

(22) Filed: May 13, 2015

Related U.S. Application Data
(60) Provisional application No. 62/051,286, filed on Sep. 16, 2014.

(51) Int. Cl. F16M 13/02; A41G 3/00; F16B 47/00

(52) U.S. Cl. CPC F16M 13/022; F16B 47/00; A41G 3/00

(57) ABSTRACT

A wig hanger includes a surface mount, a curled arm, and a movable hanger portion. The surface mount connects to a surface and attached to the curled arm which is of smooth design with a proximal end and a distal end and a loop portion at the distal end. The loop portion engages the movable hanger portion which has at least two degrees of rotational freedom.

### CROSS-REFERENCE TO RELATED APPLICATIONS

Not Applicable

### STATEMENT REGARDING FEDERALLY SPONSORED RESEARCH

Not Applicable

### FIELD OF THE INVENTION

This invention relates to a device that can be used to hang a wig in multiple positions and locations.

### BACKGROUND OF THE INVENTION

Wigs are used by many people for various reasons. When hanging a wig, it is preferable to ensure that the wig hangs freely, is easily dried, and keeps its shape. Some have used clothes hangers or other less effective devices when hanging their wigs. This can result in damage to the wig. There remains a need for a wig hanger that preserves the original shape and condition of the wig while also providing convenience and versatility when hanging the wig.

The instant invention, as disclosed within this application, fills this need. The art referred to and/or described within this application is not intended to constitute an admission that any patent, publication or other information referred to herein is “prior art” with respect to this invention. In addition, this section should not be construed to mean that a search has been made or that no other pertinent information as defined in 37 C.F.R. §1.56(a) exists.

All US patents and applications and all other published documents mentioned anywhere in this application are incorporated herein by reference in their entirety.

Without limiting the scope of the invention a brief summary of some of the claimed embodiments of the invention is set forth below. Additional details of the summarized embodiments of the invention and/or additional embodiments of the invention may be found in the Detailed Description of the Invention below.

A brief abstract of the technical disclosure in the specification is provided as well only for the purposes of complying with 37 C.F.R. 1.72. The abstract is not intended to be used for interpreting the scope of the claims.

### BRIEF SUMMARY OF THE INVENTION

In at least one embodiment of the invention a wig hanger can comprise a surface mount, a curled arm, and a movable hanger portion. The surface mount can connect to a surface and attach to the curled arm. The curled arm has a smooth design and both a proximal end and a distal end. The curled arm has a loop portion at the distal end that can engage the movable hanger portion. The movable hanger portion can have at least two degrees of rotational freedom.

In at least one embodiment, the curled arm can be removably attached to the surface mount.

In at least one embodiment, one end of the curled arm can be removably attached to the surface mount.

In at least one embodiment, the movable hanger portion can extend obliquely from a plane defined by the loop portion.

In at least one embodiment, the movable hanger portion can extend substantially perpendicularly from a plane defined by the loop portion.

In at least one embodiment, the movable hanger portion has two ends, each of the two ends can extend from the curled arm as arcs.

In at least one embodiment, the movable hanger portion can extend obliquely from a plane defined by the loop portion.

In at least one embodiment, one end of the curled arm can have a flattened portion that slidingly engages into a slot of the surface mount.

In at least one embodiment, the surface mount can be attached to a mounting surface using an attachment method that can be selected from the group consisting of command strips, screws, nails, glues, epoxies, suction, magnetism, hook and loop material, constructed to hang over a door, constructed to hang over a rod, and any combination thereof.

In at least one embodiment, a wig hanger kit can comprise a plurality of surface mounts, at least one curled arm, and at least one movable hanger portion. Each surface mount can be constructed to connect to a surface and attach to the curled arm. At least one curled arm can be of smooth design and have a proximal end and a distal end and have a loop portion at the distal end. The loop portion can engage the movable hanger portion. The movable hanger portion can have at least two degrees of rotational freedom.

In at least one embodiment the wig hangar kit can include a wig.

These and other embodiments which characterize the invention are pointed out with particularity in the claims annexed hereto and forming a part hereof. However, for further understanding of the invention, its advantages and objectives obtained by its use, reference should be made to the drawings which form a further part hereof and the accompanying descriptive matter, in which there is illustrated and described embodiments of the invention.

### BRIEF DESCRIPTION OF THE SEVERAL VIEWS OF THE DRAWING(S)

A detailed description of the invention is hereafter described with specific reference being made to the drawing.

FIG. 1 is a perspective view of an embodied wig hanger.

FIG. 2 is a perspective view of an embodied wig hanger attached to a tile wall.

FIG. 3 is a perspective view of an embodied wig hanger attached to a counter top.

FIGS. 4a-b are perspective views of mount attachments.

FIG. 5 is a front perspective view of a surface mount with a removable arm.

FIG. 6 is a side perspective view of the arm with a movable hanger portion.

FIG. 7a is a front view of an inventive arm.

FIG. 7b is a side view of an inventive arm.

FIG. 7c is a perspective view of an inventive arm.

FIG. 8a is a front view of an inventive mount.

FIG. 8b is a side view of an inventive mount.

FIG. 8c is a perspective view of an inventive mount.

FIG. 9a is a front view of an inventive “over a door” mount.

FIG. 9b is a side view of an inventive “over a door” mount.

FIG. 9c is a perspective view of an inventive “over a door” mount.

FIG. 10a is a perspective view of an inventive “over a door” mount movable hanger portion with arm and hanger attached.

FIG. 10b a front view of an inventive “over a door” mount movable hanger portion with arm and hanger attached.

FIG. 11a is a front view of an inventive movable hanger portion.

FIG. 11b is a side view of an inventive movable hanger portion.

FIG. 11c is a perspective view of an inventive movable hanger portion.

### DETAILED DESCRIPTION OF THE INVENTION

While this invention may be embodied in many different forms, there are described in detail herein specific preferred embodiments of the invention. This description is an exemplification of the principles of the invention and is not intended to limit the invention to the particular embodiments illustrated.

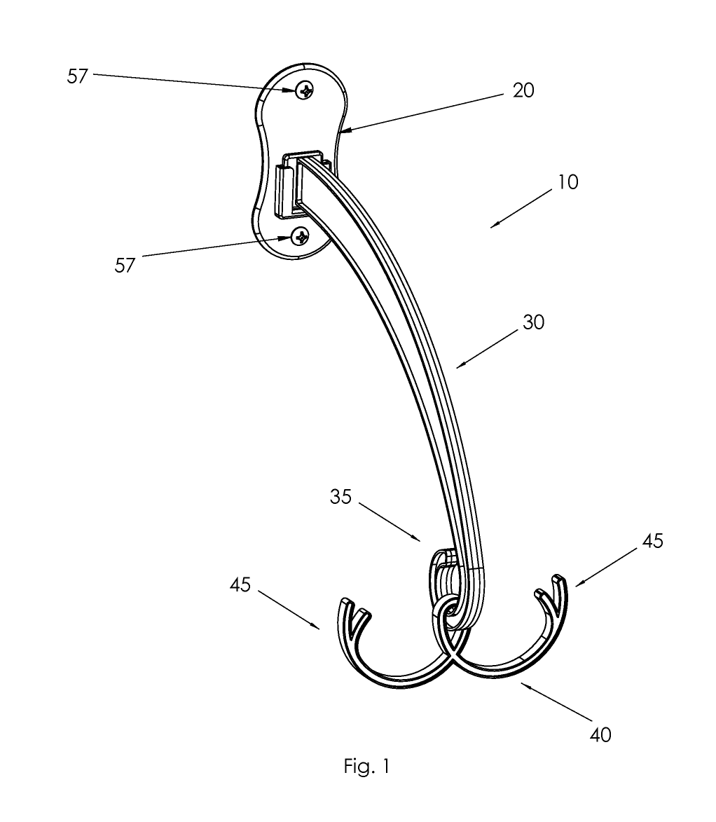

In FIG. 1, an inventive embodiment of the wig hanger 10 is shown. The wig hanger as shown has a mounting apparatus 20, an arm 30 and a movable hanger portion 40. As shown, the arm 30 attaches to the mounting apparatus 20 at its proximal end and includes a looped portion 35 at its distal end. The looped portion 35 is curled such that it keeps the movable hanger portion 40 connected to the arm 30. The movable hangar portion 40 as shown can include two arched portions 45.

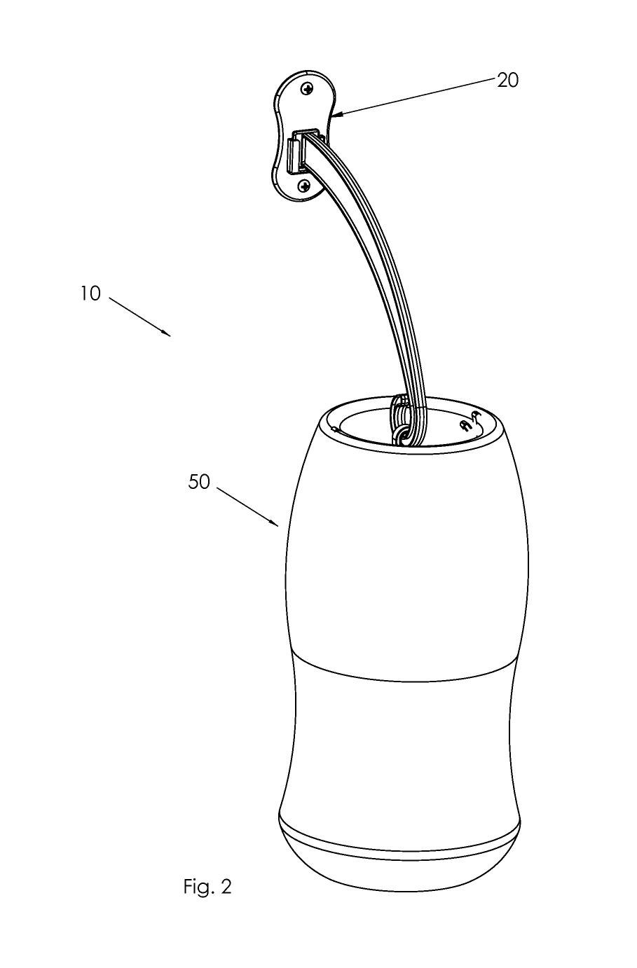

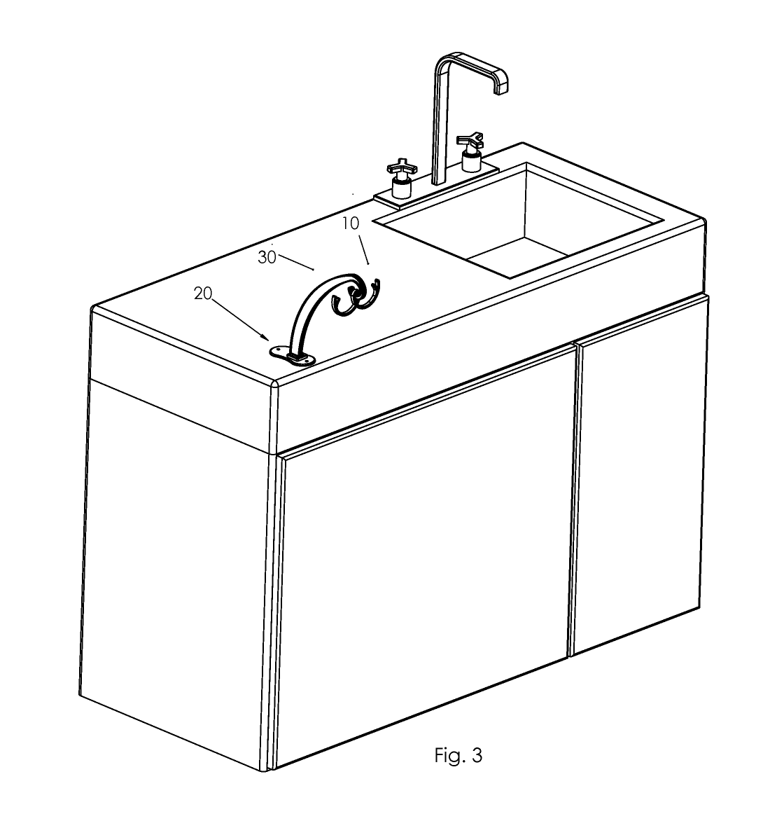

As shown in FIG. 2, in most applications the wig 50 (represented generically and without color) will hang from the arched portions 45. As shown here the wig hanger 10 is mounted on a vertical wall such as a tile wall. The wig hanger 10 can also be mounted on a horizontal surface such as a sink counter as shown in FIG. 3. Again the wig 50 hangs from the arched portions 45. Due to the design of the wig hanger 10, the movable hanger portion 40 can rotate and translate about the looped portion 35 such that the wig 50 is allowed to hang down vertically.

It should be noted that the curled arm 30 of both FIG. 2 and FIG. 3 can represent the same curled arm 30 but in different mounting apparatuses 20. The arm 30 is removably attached to the mount 20. Thus, the arm 30 with attached wig 50 in FIG. 2 can be removed from mount 20 and transported to the mount 20 on the horizontal surface of FIG. 3. It should also be further noted that in some embodiments the entire wig hanger 10 including the mount 20 and the wig are moved from the location of FIG. 2 to the location of FIG. 3 as the attachment means of the mount 20 to the surface is a temporary and easily removable means (e.g. suction cups).

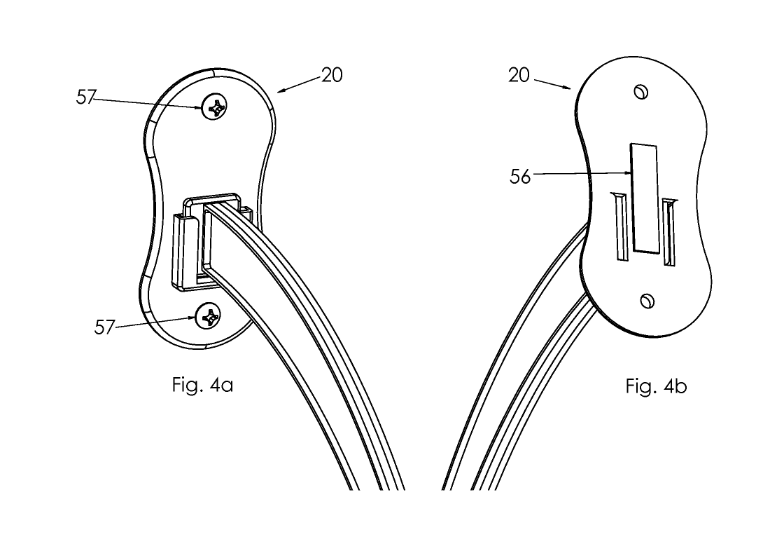

There are multiple ways in which to attach the mount 20 to a surface. In FIGS. 4a and 4b some of the ways are illustrated. In FIG. 4a screws 57 are used to more permanently attach the mount 20 to the surface. Nails, pins, and anchors could also be used to attach the mount 20.

In FIG. 4b a removable adhesive 56 is used. This can include adhesives similar to command strips. Some adhesives 56 are simply adhesives that remain adhesive through many attaching and removing cycles.

Obviously, FIGS. 4a-c are merely representative of some embodiments. Command strips, screws, nails, glues, epoxies, suction, magnetism, hook and loop material, and any combination thereof may be used as attachment means.

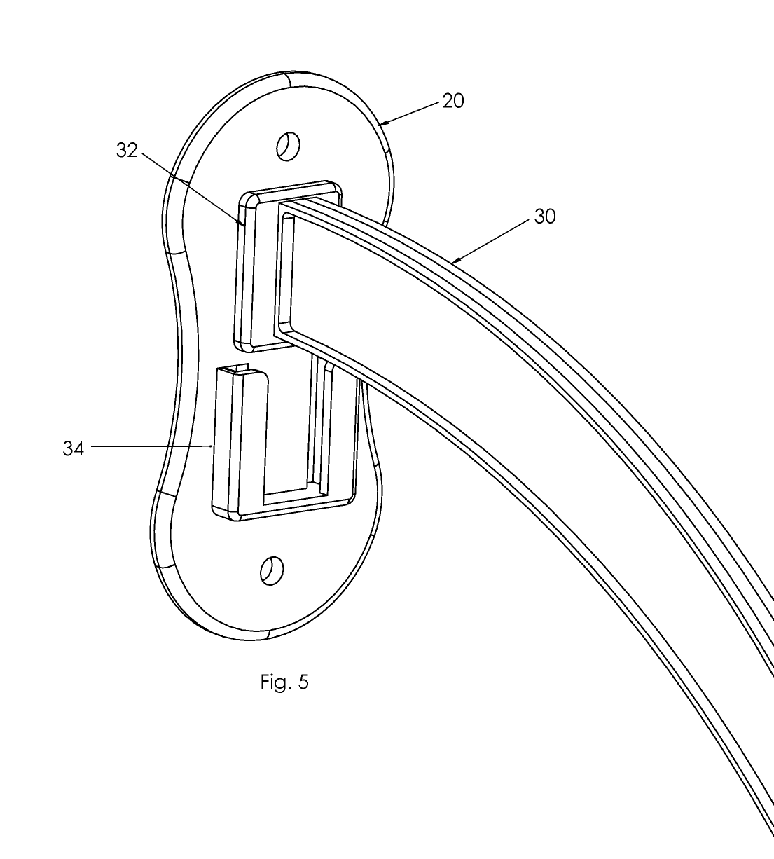

In FIG. 5 an embodied interaction between the arm 30 and the mounting apparatus 20 is shown. Arm 30 has a proximal end with an end bracket 32 that can fit into slot 34. The arm 30 can thus be moved from one mounting apparatus 20 to another. The use of command strips, adhesive, suction, magnetism, hoof and loop material, and any combination thereof are also considered as embodied interactions between the arm 30 and the mounting apparatus 20.

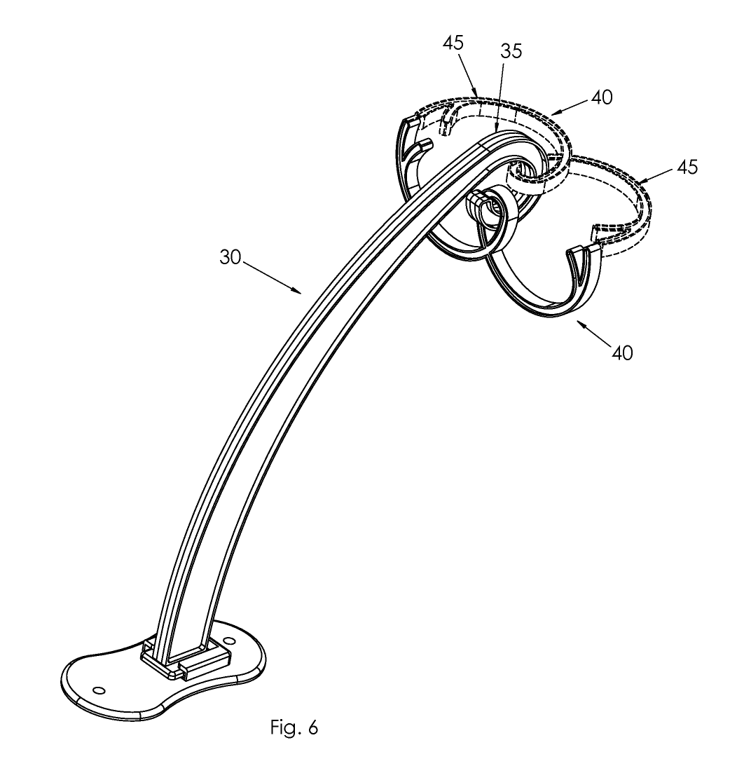

In FIG. 6 the interaction between the distal curled portion 35 of the arm 30 and the movable hanger portion 40 is shown. As shown there is a first position of the movable hanger portion 40′ and a second position of the movable hanger portion 40″. As the orientation of the arm is moved the movable hanger portion 40 is free to move along the curled portion 35 of arm 30 and to rotate as well. In a resting state the arcs 45 of the movable hanger portion 40 extend out from the curled portion 35. In some instances this is substantially close to perpendicular to the curled portion 35. However, in some embodiments and as shown, there can be additional axis of rotation as the movable hanger portion 45 can rotate substantially away from a perpendicular angle to the curled portion 35 in multiple directions. This can protect the wig 50 from damage that might occur if the hanger did not have these degrees of freedom.

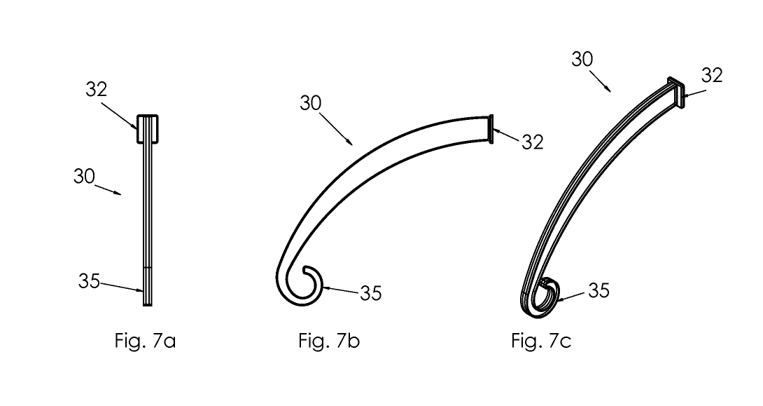

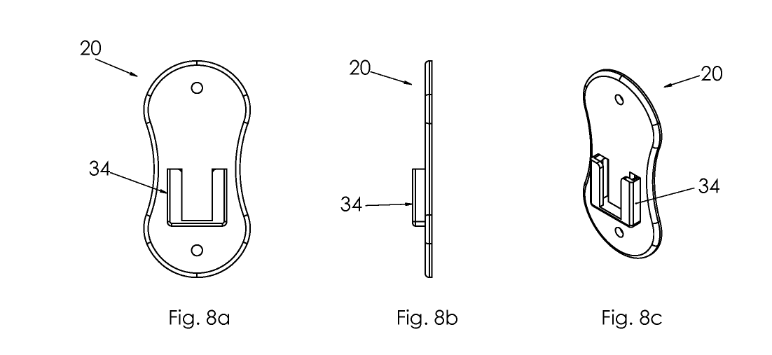

In FIGS. 7a-c an embodied arm 30 is shown. Here it has a bracket 32 that can slide in the embodied slot 34 of the mounting apparatus 20 shown in FIGS. 8a-8c.

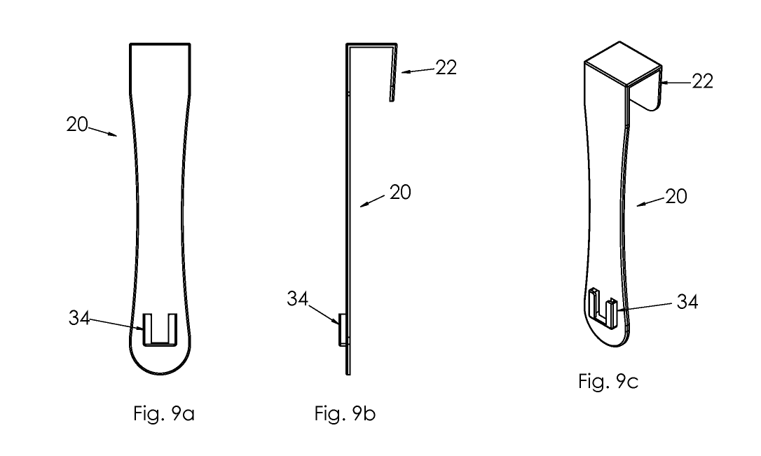

In FIGS. 9a-c a mounting apparatus 20 having a bend 22 is shown. The bend 22 can be hung over a door or other structure in order to hang and/or mount the mounting apparatus 20. The bend 22 can also be hung over a rod or similar structure to provide additional hanging options.

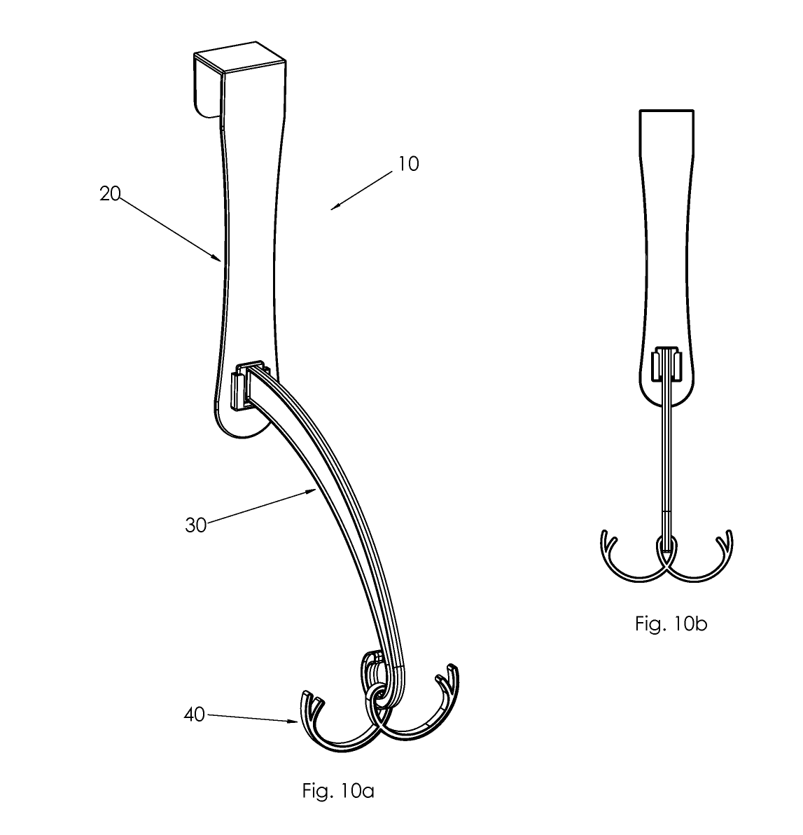

In FIG. 10a-b the mounting apparatus 20, which can be hung over any number of location (e.g. over a door or over the end of a drawer), includes an embodied and attached arm 30 with hanger 40 or any number of locations

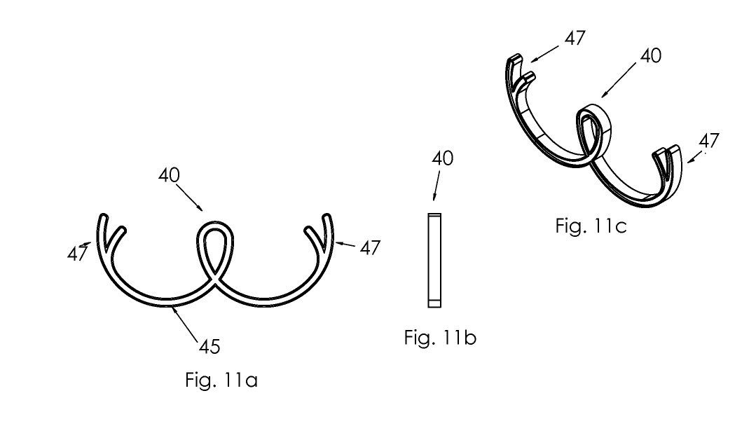

In FIGS. 11a-c a movable hanger portion is shown. The movable hanger portion 40 shown has a double tip 47 at the ends of the arcs 45. This can in some instances improve securement of the wig 50 on the movable hanger portion 40.

The above disclosure is intended to be illustrative and not exhaustive. This description will suggest many variations and alternatives to one of ordinary skill in this art. The various elements shown in the individual figures and described above may be combined or modified for combination as desired. All these alternatives and variations are intended to be included within the scope of the claims where the term “comprising” means “including, but not limited to”.

Further, the particular features presented in the dependent claims can be combined with each other in other manners within the scope of the invention such that the invention should be recognized as also specifically directed to other embodiments having any other possible combination of the features of the dependent claims. For instance, for purposes of claim publication, any dependent claim which follows should be taken as alternatively written in a multiple dependent form from all prior claims which possess all antecedents referenced in such dependent claim if such multiple dependent format is an accepted format within the jurisdiction (e.g. each claim depending directly from claim 1 should be alternatively taken as depending from all previous claims). In jurisdictions where multiple dependent claim formats are restricted, the following dependent claims should each be also taken as alternatively written in each singly dependent claim format which creates a dependency from a prior antecedent-possessing claim other than the specific claim listed in such dependent claim below.

This completes the description of the preferred and alternate embodiments of the invention. Those skilled in the art may recognize other equivalents to the specific embodiment described herein which equivalents are intended to be encompassed by the claims attached hereto.

1. A wig hanger comprising a surface mount, a curled arm, and a movable hanger portion, the surface mount connecting to a surface and attached to the curled arm, the curled arm being of smooth design and having a proximal end and a distal end and having a loop portion at the distal end, the loop portion engaging the movable hanger portion, the movable hanger portion having at least two degrees of rotational freedom.

2. The wig hanger of claim 1 wherein the curled arm is removably attached to the surface mount.

3. The wig hanger of claim 2 wherein one end of the curled arm is removably attached to the surface mount.

4. The wig hanger of claim 1 wherein the movable hanger portion extends obliquely from a plane defined by the loop portion.

5. The wig hanger of claim 1 wherein the movable hanger portion extends substantially perpendicularly from a plane defined by the loop portion.

6. The wig hanger of claim 1 wherein the movable hanger portion has two ends, each of the two ends extending from the curled arm are arcs.

7. The wig hanger of claim 1 wherein the movable hanger portion extends obliquely from a plane defined by the loop portion.

8. The wig hanger of claim 2 wherein one end of the curled arm has a flattened portion that slidingly engages into a slot of the surface mount.

9. The wig hanger of claim 1 wherein the surface mount is attached to a mounting surface using an attachment method selected from the group consisting of command strips, screws, nails, glues, epoxies, suction, magnetism, hook and loop material, constructed to hang over a door, constructed to hang over a rod, and any combination thereof.

10. A wig hanger kit comprising a plurality of surface mounts, at least one curled arm, and at least one movable hanger portion, the each surface mount constructed to connect to a surface and attach to the curled arm, the at least one curled arm being of smooth design and having a proximal end and a distal end and having a loop portion at the distal end, the loop portion engaging the at least one movable hanger portion, the at least one movable hanger portion having at least two degrees of rotational freedom.

11. The wig hangar kit of claim 10 including a wig.
